(19) United States
(12) Patent Application Publication
(10) Pub. No.: US 2008/0072487 A1
(43) Pub. Date: Mar. 27, 2008

(54) Apparatus and system to minimize damage to structures or trees during high winds

(76) Inventor: Jeffrey Jerome Lammers, Indialantic, FL (US)

Correspondence Address: Ken Thomton-Smith, 1032 Marlin Dr, Rockledge, FL, 32955, US

(21) Appl. No.: 11/510,023

(22) Filed: Aug. 26, 2006

(51) Int. Cl. A01G 17/10

(52) U.S. Cl. 47/42

(57) ABSTRACT

A temporary apparatus to prevent damage to structures such as screen enclosures during high winds. The apparatus uses a proprietary bracket specifically designed for target structure members that is permanently attached to the structural member, a ground anchor, which may be any permanent or temporary fixture that may be used as a ground anchor; and any tie-down material or method that may be used to temporarily tie said bracket to said ground anchor. Alternatively, a temporary apparatus to prevent damage to trees or poles during high winds or other vulnerable times. The apparatus uses a proprietary bracket specifically designed for structural members that may be permanently or temporarily attached, and the whole is secured with similar anchors and temporary tie-down materials. The bracket is so designed that it increases its grip on the structural member as wind loading increases.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of construction and more specifically to an apparatus to minimize damage to structures or trees during high winds.

The southeast of the United States is subject to increasingly violent hurricanes. At the same time, the population of the southeast has increased dramatically, having doubled in the last 15 years. The rising affluence of the southeast has resulted in a large number of screen enclosures to protect participants in outdoor activities from insects.

Screen enclosure cost is largely a function of size, but typically they are in the range of $10,000-$50,000. It goes without saying that screen enclosures are frail and easily damaged structures that are extremely vulnerable to hurricane damage.

Many homeowners will put up plywood or shutters to protect their home in the event of a hurricane, and there are many such protection methods on the market. There are no commercial systems available for high wind protection of structures such as screen enclosures. Any protection to date has been on an individual ad hoc basis.

There are many commercial systems available to tie-down insecure structures such as trailers. These normally comprise ground anchors and strapping that passes over or attaches to the trailer. There is no commercial trailer system that could be easily adapted to provide an effective tie-down method for screen enclosures.

Further, many yards contain trees which are certainly expensive enough to be the subject of insurance claims but are capable of inflicting damage 10 times their value. Similarly, and despite the potential for damage, there is no commercial temporary tie-down apparatus for the high wind protection of trees. In addition, there are other vulnerable periods when tiedowns are required such as during the first few weeks when the tree is rooting, and while cement is setting around poles or fence posts.

With no commercial systems available, homeowners may have tried simple homemade approaches to the protection of structures such as screen enclosures and trees. There are several obvious deficiencies in this typical ad hoc approach, including:
the difficulty of securing the tie-down to the screen enclosure frame;
the difficulty of securing the tie-down to structural members;
the difficulty of obtaining suitable tie-down material;
lack of engineering knowledge such as wind loading; and,
house protection assuming priority over screen enclosure, trees etc.

Most homeowners will attempt to protect the house first as the house can be worth up to 10 times the value of the screen enclosure. The huge numbers of damaged screen enclosures during recent hurricanes demonstrates that screen enclosures receive a low priority or may even be considered expendable in the light of no commercially available solution.

In addition to screen enclosures, many other external structures such as fences, gates, sheds, playground equipment, flagpoles, billboards, signs, marquees and awnings have demonstrated vulnerability to high wind conditions.

Similarly, trees have been given a low priority simply because no effective commercial system exists. In the case of many trees such as palm trees, which have no substantial lateral branches, it is not easy to improvise an ad hoc system that prevents the tiedown system from sliding down the palm tree under high wind load.

Further to the direct costs of repairing or replacing wind-damaged structures are the additional costs incurred when the wind liberated items turn into dangerous missiles. Apart from third-party damage, such items have been responsible for injuries and even fatalities.

### BRIEF SUMMARY OF THE INVENTION

The primary object of the invention is to provide an effective temporary hurricane tie-down system for structures.

An alternative object of the invention is to provide effective temporary hurricane tie-downs for trees, poles or similar structural members.

Another object of the invention is to provide a hurricane tie-down apparatus that can be installed and implemented by the average home owner.

Another object of the invention is to provide a hurricane tie-down apparatus that is cost-effective.

A further object of the invention is to provide a hurricane tie-down apparatus that can be quickly assembled and dismantled by the average homeowner.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus to prevent damage to structures such as screen enclosures during high winds comprising: a proprietary bracket specifically designed for screen enclosure extrusions, a ground anchor, any permanent or temporary secure fixture that may be used as a ground anchor, and any tie-down material or method that may be used to temporarily tie the bracket to a ground anchor.

In accordance with an alternative preferred embodiment of the invention, there is disclosed an apparatus to protect trees or poles during high winds comprising: a proprietary bracket specifically designed for longitudinal structural members such as trees or poles, a ground anchor or any permanent or temporary secure fixture that may be used as a ground anchor, and any tie-down material or method that may be used to temporarily tie the bracket to a ground anchor.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an elevational view of the invention applied to a structure.

FIG. 2 is a perspective view of a preferred embodiment of the invention applied to a structure.

FIG. 3 is an elevational view of the invention applied to a tree.

FIG. 4 is a perspective view of the preferred embodiment invention applied to a tree or pole.

FIG. 5 is an elevational view of the preferred embodiment of the invention of FIG. 3 showing its function.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

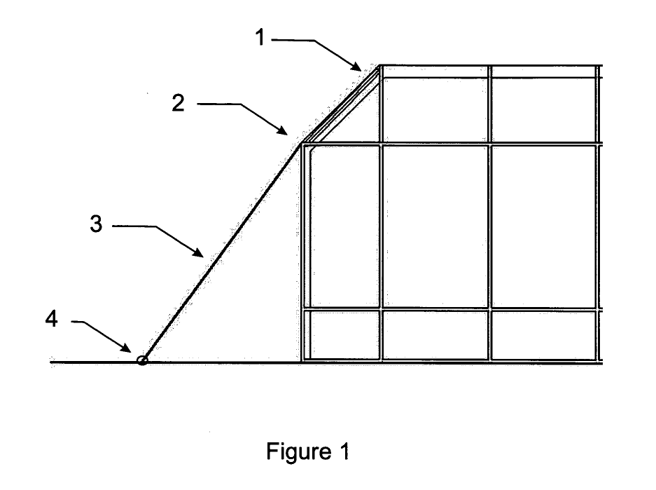

Turning now to the drawings of the apparatus, it can be seen in elevational view FIG. 1 that item 2 is a bracket that is permanently attached to the structure frame item 1. Item 4 is any temporary or permanent ground anchor or fixture location, and item 3 is any temporary tiedown material. Depending on structure type and wind loading conditions, in addition to the one anchor item 4 and one bracket item 2 in the illustration, the tiedown system may comprise one anchor item 4 and a plurality of brackets item 2, or one bracket item 2 and a plurality of anchors item 4. A structure may have one system as described above or a plurality of such systems.

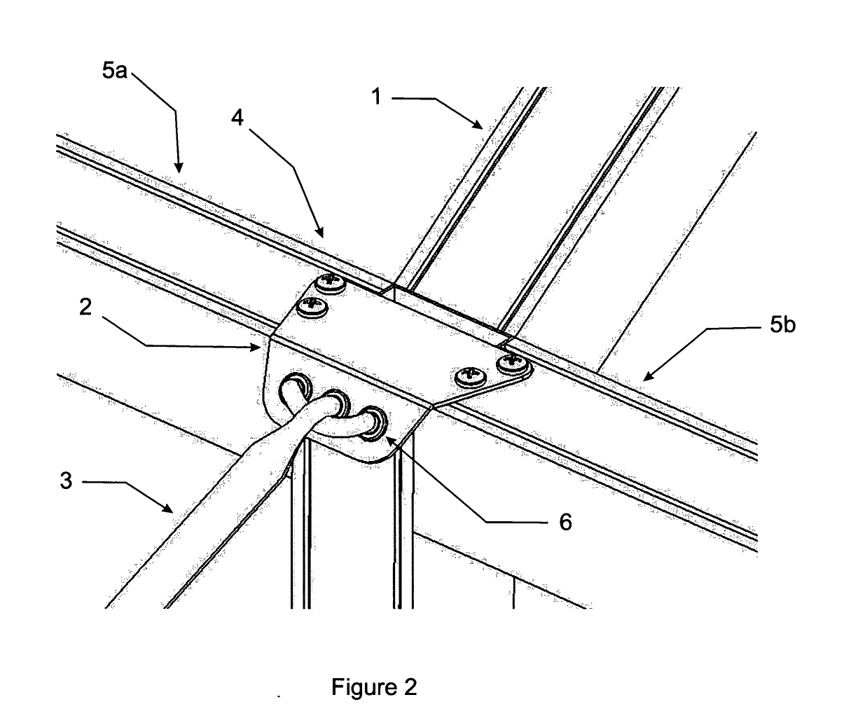

In accordance with a preferred embodiment of the present invention, it can be seen in perspective view FIG. 2 that item 2 is a bracket specifically designed for attachment to screen enclosure extrusions. This is accomplished by the following means:

The mounting holes in the bracket FIG. 2 item 2 showing the preferred embodiment are designed to spread any resultant wind load into the target screen enclosure extrusion using the fasteners item 4.

Further, the mounting holes in the bracket FIG. 2 item 2 are designed to bridge the frame members where many screen enclosure horizontal longerons item 5a and item 5b are interrupted by vertical trusses item 1.

The tiedown holes in FIG. 2 item 2 are designed to provide optimal tiedown security. Further, the tiedown holes in the preferred embodiment contain smooth plastic members item 6 to reduce chafing during high wind conditions.

It is obvious from the foregoing that the invention is not necessarily limited to the illustrative preferred embodiment, but can comprise any means of tiedown attachment to structures such as screen enclosure frames, including structural extrusion enhancements designed specifically for this purpose.

Further, that the system comprising any permanent bracket, any temporary or permanent anchor and any temporary tiedown may also be applied to other structures that may be subject to excessive wind loading. Other structures might include, but are not necessarily limited to, articles such as sheds, fences, billboards, marquees, signs, gates and playground equipment.

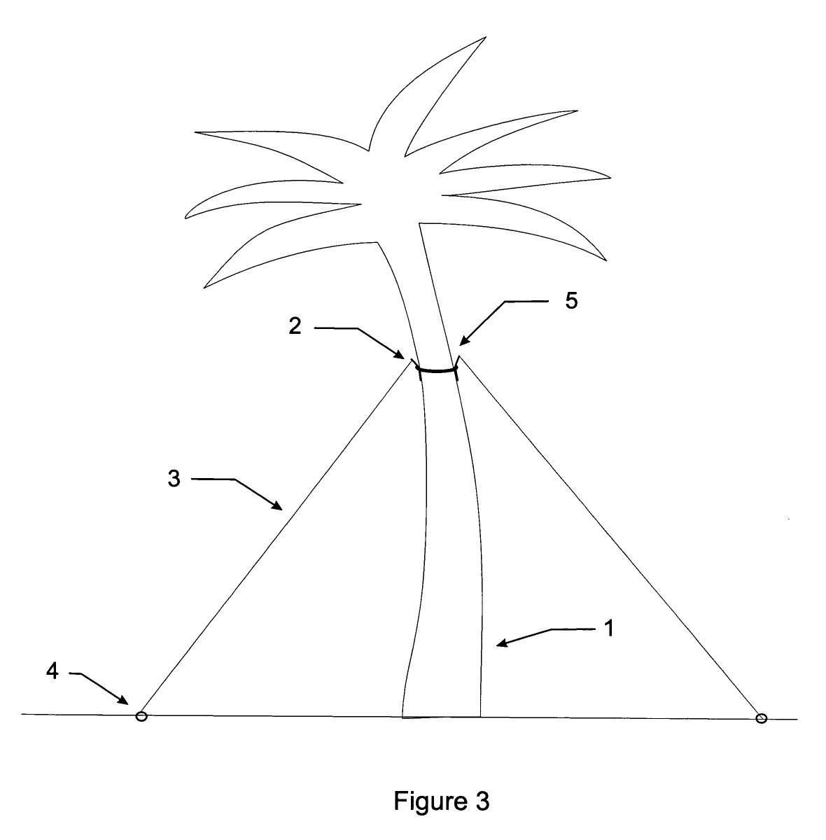

Turning now to the next drawing, it can be seen in elevational view FIG. 3 that a pole or tree item 1 can be similarly secured against high wind damage by means of an attachment method comprising one or a plurality of brackets item 2 and a strap item 5, a ground anchor or fixture item 4 and a tiedown material item 3.

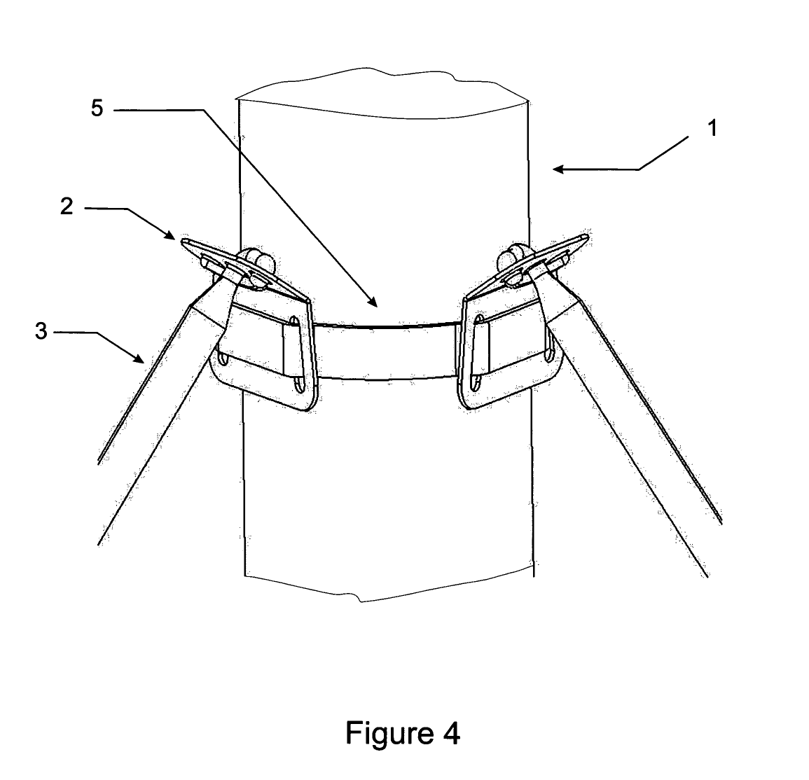

The next drawing, FIG. 4, shows a perspective detail of the alternative preferred embodiment system comprising:

A proprietary bracket item 2 that is attached to the tree or pole item 1 using strapping item 5. One bracket or a plurality thereof may be attached to the trunk or limb using straps. A tie-down item 3 is secured to the bracket item 3 and thence to a ground anchor or fixture or a plurality thereof.

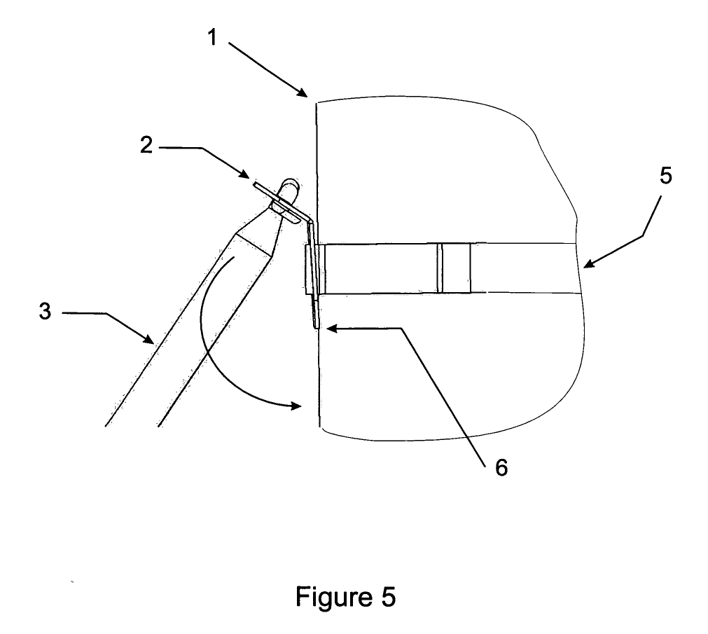

Turning now to elevational detail drawing FIG. 5, a particular feature of the preferred embodiment is that the tree bracket item 2 secured to the tree or pole with a strap item 5 wherein the wind loading forces are applied to the top of the bracket item 2 by the tie-down item 3, act away from the nominal axis of rotation location 6 causing a couple and effectively rotating the bracket item 2. When the bracket item 2 is rotated, the tension on the strapping item 5 is increased and the bottom edge of the bracket item 2 presents a smaller area thereby increasing pressure on the tree or pole item 1. In this manner, increased wind loading serves to tighten the attachment, preventing the bracket item 2 sliding down the tree or structural pole item 1.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus to prevent damage to structures during high winds, comprising:
A proprietary bracket or other attachment specifically designed for the target structure or a plurality thereof;
A ground anchor or a plurality thereof or;
Any temporary secure fixture that may be used as a ground anchor; and
Any tie-down material or method that may be used to temporarily tie the bracket to a ground anchor.

2. The apparatus of claim 1 wherein the bracket or attachment is an integral part of the structural frame.

3. The apparatus of claim 1 wherein the ground anchor is part of or attached to a permanent structure.

4. The apparatus of claim 1 wherein the tie-down material may be a temporary rigid member or a plurality thereof.

5. An apparatus to prevent damage to trees, playground apparatus or poles or any item similarly constructed of longitudinal members during high winds or other vulnerable times comprising:
A proprietary bracket or attachment specifically designed for the target structural component type or a plurality thereof;
A ground anchor or a plurality thereof or;
Any temporary secure fixture that may be used as a ground anchor; and
Any tie-down material or method that may be used to temporarily tie the bracket to a ground anchor.

6. The apparatus of claim 5 when the ground anchor is part of or attached to a permanent structure.

7. The apparatus of claim 5 wherein the tie-down material may be a temporary rigid member or a plurality thereof.

8. The apparatus of claim 5 wherein the bracket or attachment is designed to rotate under load and thereby increase pressure on the structural component to prevent bracket or attachment movement relative to the structure.
